(19) United States
(12) Patent Application Publication
(10) Pub. No.: US 2024/0320694 A1
(43) Pub. Date: Sep. 26, 2024

(54) SYSTEMS AND METHODS FOR GENERATING A TREND FORECAST AND AN EXPLANATION

(71) Applicant: Panasonic Intellectual Property Management Co., Ltd., Osaka (JP)

(72) Inventors: Debdeep PAUL, Singapore (SG); Sahim YAMAURA, Singapore (SG); Chandra Suwandi WIJAUA, Singapore (SG)

(21) Appl. No.: 18/124,302

(22) Filed: Mar. 21, 2023

(51) Int. Cl. G06Q 30/0202; G06N 7/01

(52) U.S. Cl. CPC G06Q 30/0202; G06N 7/01

(57) ABSTRACT

According to an embodiment, a method for generating and explaining trend forecast of a timeseries with measures of quality of explainability is disclosed. The method comprises receiving a target variable and a set of relevant feature(s) corresponding to the variable. The method comprises performing a classification for the target variable, wherein the classification indicates classifying the target variable into a one or more states. Further, the method comprises determining a state transition matrices for each timestamp and design appropriate functions to model and quantify the trend forecast via a state transition score. The state transition score indicates transition between the corresponding states, wherein states may be obtained through suitable encoding of the target variable, and generating and explaining trend forecast based on the state transition.

### FIELD OF THE INVENTION

The present invention generally relates to generating forecasts, and more particularly relates to systems and methods for generating and explaining trend forecast, interpretable to the user.

### BACKGROUND

As is appreciated by those familiar with the art, time series analysis helps in analysing the past, which comes in handy to forecast the future. More specifically, time series analysis may be considered as an ordered sequence of values of a variable at equally spaced time intervals. Time series analysis may be used to understand the determining factors and structure behind the observed data, choose a model to forecast, thereby leading to better decision making.

The timeseries analysis methodology is extensively employed in various practice areas such as, but not limited to, finance, healthcare, communication systems, power systems, business metrices, Internet of Things (IoT), to generate forecasts based on the historical pattern of data points collected over time and comparing it with the current trends. Such methodology may be further used by entities for decision making and policy planning. For instance, such analysis is applied for stock market analysis, economic forecasting, inventory studies, budgetary analysis, census analysis, yield projection, sales forecasting. In such examples, the time series analysis techniques utilize historical data to analyse patterns and trends, issues related to seasonality and cyclical fluctuation to forecast the future. Particularly, it is widely popular in investment to track the price of a security over a period.

In timeseries analysis, the changes in data due to change in a variable over the same time is determined. For instance, a change in stock share price depending on an economic variable like the unemployment rate can also be recorded through time series analysis. It brings out the pattern of a situation reflecting the relationship between the data points and the variable. One common approach for time series analysis may be generating a forecast of the timeseries which includes scientific predictions based on historical time stamped data. It involves building models through historical analysis and using them to make observations and drive future strategic decision-making.

In some traditional techniques, different modelling methods such as Autoregressive Integrated Moving Average model (ARIMA), a stationary model, Moving Average Model, etc. may be used to generate forecast. However, machine learning models often face big challenges to perform if the variable to be forecasted may have to detect a change point detection.

The above problem makes the traditional ML solutions largely ineffective, and incomplete as change point detection in the timeseries may not be precisely utilised to generate forecast. Change point detection is a technique to partition the data into segments such that the data points within a segment have similar statistical properties or might have been generated from the same probability distribution. The boundary between two segments can be considered as the point of change where the characteristics of two segments undergoes some changes in the inherent process in terms of probability distribution of the inherent process for generating observations. In a multitude of practical scenarios, the change points are of critical significance. Such points provide inputs for planning, resource provisioning, decision making, and managing the underlying systems. Further, the modelling methods may also lack input receiving capability such as receiving a user defined character or pattern for generating a forecast. The traditional techniques may be able to generate forecast based on certain conditions at a specific time. Such conditions may be understood as one or more states which may be predefined in the timeseries. Whereas, from the user perspective, the user may desire large number of states which may not be predefined in the timeseries, and the user may desire to generate the forecast based on the desired states. For example, in a stock price timeseries, the one or more states may be predefined indicating increase or decrease in the stock price. However, the user may not be able to define the one or more states other than predefined one or more states present in the model such as plummet, recovery from plummet, drastic change, medium change, stable etc. for timeseries forecasting.

Further, it may also be critical to create an explainable AI for the generated forecast to enhance end user's understanding on the underlying decision-making processes of the technique they are expected to employ, especially in high-stakes situations.

In addition to predictions, ML models are capable of producing knowledge about domain relationships contained in data, often referred to as explanations through which useful inferences may be drawn. Explanations help in evaluating a learned model, providing information to modify a model, and gaining trust of users. However, the traditional techniques do not provide an explainable AI model or explanation of the forecast.

There is a need for a solution that provides generation of forecast with user-defined features and further generate explainable trend forecast by leveraging appropriate mathematical models and methods to solve the above explained problems.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

According to an embodiment of the present disclosure, a system for generating a trend forecast and an explanation of the trend forecast of a data model. The system includes a memory, at least one processor communicably coupled to the memory. The at least one processor is configured to receive at least one target variable and at least one feature corresponding to the at least one target variable, wherein the at least one target variable indicates an attribute represented in the data model and the at least one feature indicates representation of properties corresponding to the data model. The at least one processor is configured to perform a classification for the at least one target variable, wherein the classification indicates classifying the at least one target variable into a one or more states. The at least one processor is configured to determine a state transition for the one or more states based on the classification, wherein the state transition indicates a probability value of transition between each of the one or more states; and generate the trend forecast and an explanation of the trend based on the state transition.

According to another embodiment of the present disclosure, a method for generating a trend forecast and an explanation of the trend forecast of a data model. The method includes receiving at least one target variable and at least one feature corresponding to the at least one target variable, wherein the at least one target variable indicates an attribute represented in the data model and the at least one feature indicates representation of properties corresponding to the data model. The method includes performing a classification for the at least one target variable, wherein the classification indicates classifying the at least one target variable into a one or more states. The method includes determining a state transition for the one or more states based on the classification, wherein the state transition indicates a probability value of transition between each of the one or more states; and generating the trend forecast based on a state transition framework and provide explanation for the users to related it back with the features/market conditions.

To further clarify the advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic block diagram of a system 100 for generating a trend forecast and an explanation of the trend forecast of a data model, according to an embodiment of the present disclosure;

FIG. 2 illustrates a detailed view of modules 106 within a schematic block diagram of the system 100 for generating the trend forecast and the explanation of the trend forecast of the data model, according to an embodiment of the present disclosure;

FIG. 3 illustrates an exemplary process flow comprising a method 300 for generating the trend forecast and the explanation of the trend forecast of the data model, according to an embodiment of the present disclosure;

FIGS. 4A and 4B illustrate another exemplary process flow comprising a method 400a and a graphical user interface (GUI) 400b respectively for generating and explaining the trend forecast of the data model, according to an embodiment of the present disclosure; and

FIG. 5 illustrates another exemplary block diagram depicting a process flow comprising a method 500 for generating the trend forecast and the explanation of the trend forecast of the data model, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The present disclosure proposes an explainable trend forecasting through probabilistic modelling using Markov Chain Model (MCM) and flexible class encoding model architecture to address the issues of accepting any number of states of interest and using state transition probability matrix to model and compute the probability function corresponding to any user-defined trend. Further, the present disclosure proposes generation of explanation for the trend forecasting as described above.

The present disclosure is directed towards a method and system for generating a trend forecast and an explanation of the trend forecast of a data model. In the system, a target variable, a corresponding feature, and one or more states are provided as inputs for generating the trend forecast. Thereafter, a method for feature selection in neural networks is used to extract features and generate the explanation of the trend forecast.

According to various embodiments of the present disclosure, a forecasting methodology to address the issues of generating trend forecast based on the user-defined trend and states along with the explanation of the trend forecast is disclosed.

Conventionally, it is observed that the methods for forecasting timeseries may use Autoregressive integrated moving average (ARIMA) model, Seasonal Autoregressive Integrated Moving-Average (SARIMA), TBATS. In such methods, ML based paradigms, typically a set of related features are used to train different ML models and the forecast is made on the unseen data. Therefore, the present disclosure is directed towards utilizing the target variable, the corresponding feature, the user-defined one or more states, and the trend pattern received as inputs and applying Markov chain model to generate the trend forecast for each timestamp. Further, the explanation method such as, but not limited to, rule-based, feature-importance based method may be used. Particularly, lime, SHAP, etc. technique is used to generate the explanation of the generated trend forecast.

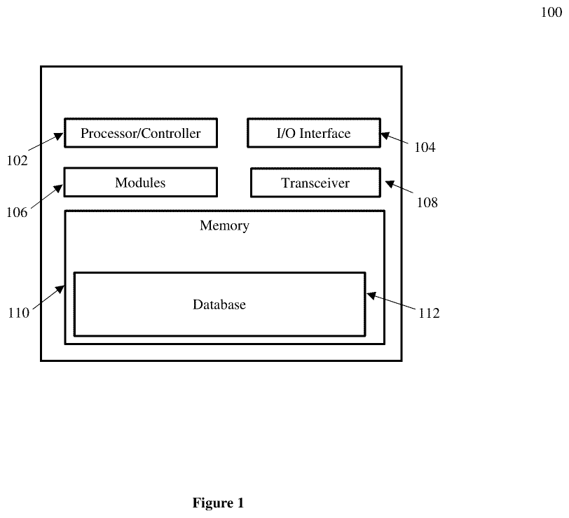

FIG. 1 illustrates a schematic block diagram of a system 100 for generating the trend forecast and the explanation of the trend forecast of the data model, according to an embodiment of the present disclosure. In one embodiment, the system 100 may be used to implement the methods for generating the trend forecast and the explanation of the trend forecast of the data model, as discussed hereinafter.

In one embodiment, the system 100 may be included within a mobile device or a server. Examples of mobile device may include, but not limited to, a laptop, smart phone, a tablet, or any electronic device having a capability to access internet and to install a software application(s). The system 100 may further include a processor/controller 102, an I/O interface 104, modules 106, transceiver 108, and a memory 110.

In some embodiments, the memory 110 may be communicatively coupled to the at least one processor/controller 102. The memory 110 may be configured to store data, instructions executable by the at least one processor/controller 102. In some embodiments, the modules 106 may be included within the memory 110. The memory 110 may further include a database 112 to store data. The one or more modules 106 may include a set of instructions that may be executed to cause the system 100 to perform any one or more of the methods disclosed herein. The one or more modules 106 may be configured to perform the steps of the present disclosure using the data stored in the database 112, to perform forecasting of the timeseries, as discussed throughout this disclosure. In an embodiment, each of the one or more modules 106 may be a hardware unit which may be outside the memory 110. The transceiver 108 may be capable of receiving and transmitting signals to and from system 100. The I/O interface 104 may include a display interface configured to receive user inputs and display output of the system 100 for the user(s). Specifically, the I/O interface 104 may provide a display function and one or more physical buttons on the system 100 to input/output various functions, as discussed herein. Other forms of input/output such as by voice, gesture, signals, etc. are well within the scope of the present disclosure. For the sake of brevity, the architecture and standard operations of memory 110, database 112, processor/controller 102, transceiver 108, and I/O interface 104 are not discussed in detail. In one embodiment, the database 112 may be configured to store the information as required by the one or more modules 106 and processor/controller 102 to perform one or more functions to generate the trend forecast and the explanation of the trend forecast.

In one embodiment, the memory 110 may communicate via a bus (not shown) within the system 100. The memory 110 may include, but not limited to, a non-transitory computer-readable storage media, such as various types of volatile and non-volatile storage media including, but not limited to, random access memory, read-only memory, programmable read-only memory, electrically programmable read-only memory, electrically erasable read-only memory, flash memory, magnetic tape or disk, optical media and the like. In one example, the memory 110 may include a cache or random-access memory for the processor/controller 102. In alternative examples, the memory 110 is separate from the processor/controller 102, such as a cache memory of a processor, the system memory, or other memory. The memory 110 may be an external storage device or database for storing data. The memory 110 may be operable to store instructions executable by the processor/controller 102. The functions, acts or tasks illustrated in the figures or described may be performed by the programmed processor/controller 102 for executing the instructions stored in the memory 110. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing, and the like.

Further, the present invention contemplates a computer-readable medium that includes instructions or receives and executes instructions responsive to a propagated signal, so that a device connected to a network may communicate voice, video, audio, images, or any other data over a network. Further, the instructions may be transmitted or received over the network via a communication port or interface or using a bus (not shown). The communication port or interface may be a part of the processor/controller 102 or maybe a separate component. The communication port may be created in software or maybe a physical connection in hardware. The communication port may be configured to connect with a network, external media, the display, or any other components in system 100, or combinations thereof. The connection with the network may be a physical connection, such as a wired Ethernet connection or may be established wirelessly. Likewise, the additional connections with other components of the system 100 may be physical or may be established wirelessly. The network may alternatively be directly connected to the bus.

In one embodiment, the processor/controller 102 may include at least one data processor for executing processes in Virtual Storage Area Network. The processor/controller 102 may include specialized processing units such as, integrated system (bus) controllers, memory management control units, floating point units, graphics processing units, digital signal processing units, etc. In one embodiment, the processor/controller 102 may include a central processing unit (CPU), a graphics processing unit (GPU), or both. The processor/controller 102 may be one or more general processors, digital signal processors, application-specific integrated circuits, field-programmable gate arrays, servers, networks, digital circuits, analog circuits, combinations thereof, or other now known or later developed devices for analyzing and processing data. The processor/controller 102 may implement a software program, such as code generated manually (i.e., programmed).

The processor/controller 102 may be disposed in communication with one or more input/output (I/O) devices via the I/O interface 104. The I/O interface 104 may employ communication code-division multiple access (CDMA), high-speed packet access (HSPA+), global system for mobile communications (GSM), long-term evolution (LTE), WiMax, or the like, etc.

The processor/controller 102 may be disposed in communication with a communication network via a network interface. The network interface may be the I/O interface 104. The network interface may connect to a communication network. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include, without limitation, a direct interconnection, local area network (LAN), wide area network (WAN), wireless network (e.g., using Wireless Application Protocol), the Internet, etc. The network interface may employ connection protocols including, but not limited to, direct connect, Ethernet (e.g., twisted pair 10/100/1000 Base T), transmission control protocol/internet protocol (TCP/IP), token ring, IEEE 802.11a/b/g/n/x, etc.

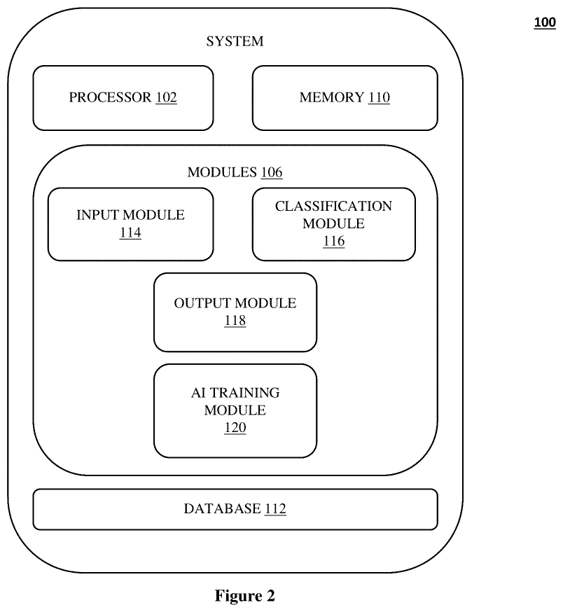

FIG. 2 illustrates a detailed view of the modules 106 within a schematic block diagram of the system 100 for generating the trend forecast and the explanation of the trend forecast of the data model, according to an embodiment of the present disclosure. The processor 202 via the modules 206 is configured to execute machine-readable instructions (software) which perform the working of the system 100 within the scope of the present disclosure as described in forthcoming paragraphs.

As illustrated, in one embodiment, the one or more modules 106 may include an input module 114, a classification module 116, an output module 118, and an artificial intelligence (AI) training module 120.

In one embodiment, the input module 114 may be configured to receive a data model. The data model may include historical data, for example, historical data of the car sales or historical data of the stock price. Further, the data model may indicate a transformation of timeseries. The timeseries may be related to any process such as in an instance, a temperature data of a city may include maximum temperature in a day, minimum temperature in the day, etc.

Further, the input module 114 may be configured to receive the target variable and the set of features corresponding to the target variable. The target variable may indicate an attribute or element represented in the data model for which the trend forecast needs to be generated. The target variable may include, but not limited to, temperature and a stock price. The target variable may be a quantity or a data item for which the trend forecast needs to be generated. Further, the set of features may indicate representation of properties corresponding to the target variable. The set of features may include, but not limited to, information content, correlation and other metrices, such as, temperature indices, automotive market indices, stock price of relevant companies, etc. For example, in stock price monitoring, a user will provide the target variable such as requesting the recovery of stock price. Now, corresponding to such target variable, there may be the set of features such as market indices of stock, revenue of the company. The set of features may vary according to the target variable.

Further, the input module 114 may be configured to receive one or more states. For example, 2-3 states may be defined for classifying the target variable into the one or more states. The one or more states may indicate divisions in the data model in which the target variable may be classified based on a predefined condition. For example, the one or more states may include, but not limited to, a high, a medium, and a low state of stock price. In another example, the one or more states may include, but not limited to, a high, a medium, and a low state of temperature. In the aforementioned examples, the condition including a threshold of the stock price or the temperature may be pre-defined for each of the one or more states. Thus, the target variable, i.e., the stock price or the temperature may be classified as in the states of high, medium, and low based on the predefined condition that the target variable may demonstrates in the data model. For example, the predefined condition for each of the one or more states, may include, but limited to:

High: if temperature (target variable) is greater than 100° C.; Medium if temperature (target variable) is between 50° C.-100° C.; Low if temperature (target variable) is below 50° C.

Additionally, the input module 114 may be configured to receive an input for selecting the logic for generating the trend forecast in form of a trend input may be from the user. The trend input may indicate a pattern for generating the trend forecast based on the one or more states. For example, the trend input may include, but not limited to, recovery from monotonic decrease in temperature and plummet recovery of the stock price.

Additionally, the input module 114 may be configured to receive one or more inputs associated with the selection of one or more prediction machine learning models for generating the trend forecast. The one or more prediction machine learning models may include, but not limited to, linear models, non-linear models, tree-based models, gradient boost, random forest, neural network (along with number of layers), etc. In an example, the one or more prediction machine learning models may be pre-trained models, trained on large dataset or alternatively may be also be trained during the process, within the scope of the invention.

In one embodiment, the classification module 116 may be configured to perform a classification of the target variable. The classification indicates classifying the target variable into one or more states as received by the input module 114. In an example, the classification module 116 may be configured to apply Markov-chain model for classifying the target variable, such that the target variable with a continuous variables is classified into one or more states of discrete variables. In the example, based on the predefined condition(s) provided at the input module 114, the target variable may be classified into the one or more states. For example, the temperature may be classified as in the state of high if the temperature is greater than 100° C., medium if temperature is between 50° C.-100° C. and low if temperature is below 50° C. Thus, the target variable, i.e., the temperature is classified into the one or more states as provided to the input module 114 and in accordance with the logic of the predefined condition(s) provided as input.

Further, in some embodiments, the classification module 116 may be configured to generate a state transition probability matrix. The state transition probability matrix may indicate probabilities of the target variable transitioning from one state to another in a single time unit. The single time unit may also be known as a timestamp in the trend forecast indicating a specific time for which the state transition probability matrix may be generated.

In an exemplary embodiment, the classification module 116 may be configured to apply the Markov-chain model to determine a state transition or the state transition probability matrix based on the one or more states based on the classification of the target variable from the data model into one or more states. The state transition indicates a probability value of transition between each of the one or more states and can be represented by a transition probability score thus, generating the state transition probability matrix. For example, the transition probability score may indicate a probability value of transition of the target variable between the each of two states in the state transition probability matrix. The state transition probability matrix may provide the probability value for transition of the target variable from one state to another. For example, if the present state of the target variable indicates low temperature, then the transition probability score may indicate the probability value of transition from the present state, i.e., low to any of the one or more states.

In some embodiments, the output module 118 may be configured to output or generate the trend forecast based on the transition probability score and the user-defined trend input. The final forecast may be output on a graphical/display user interface associated with the system 100. Specifically, the output module 118 may be configured to select a feature for generating the explainability of the trend forecast. In an example, the feature may be selected from the set of features received in the input module 114 using sparse feature selection method such as LassoNet.

Further, the output module 118 may be configured to generate an explanation of the generated trend forecast based on the selected feature. The explanation may indicate applying the explainable AI method on the generated trend forecast that enables the user to gain an understanding of the decisions made by the ML models to generate the trend forecast. In an example, a SHapley Additive explanations (SHAP) is used to create explanation of the generated trend forecast.

Further, the output module 118 may be configured to determine quality of the generated explanation. In an example, the quality may be determined on the basis of an informative score and a relevance score generated for the generated explanation, as detailed hereinafter.

In an example, in the relevance score is computed based on quality of the generated trend forecast. The quality of the model to produce explanation consistent with business logic may determine the relevance matrix score. For instance, for a month, if the major fraction of the sales comes from products used in auto market, then indices related to auto market should contribute more for the corresponding month. In the example, the relevance matrix is determined by pre-defined business logic inputs from the user, wherein the user may be expert in determining the quality of the explainability based on methodically designed questionnaire, user surveys etc.

In another example, the informativeness score is computed based on the variability of the feature attributes pertaining to the explanations generated for the trend forecast. The informativeness may further indicate the amount of information revealed by the explanation generated corresponding to the trend forecast. The informative score may be determined by the sharpness of the selected feature attributes such as the variance in the computed score. Thus, the higher the variance, the higher is the information content. SHAP is used for interpreting predictions for assigning each feature an important value for a specific prediction.

The output module 118 may be configured to generate the explainability based on the informative score the relevance score. In an example, the output module 118 may be configured to generate more than one explanation of the generated trend forecast. Each of the explanation may include the informative score and the relevance score. In the example, a combined mean value of the informative score and the relevance score for each explanation is determined. The output module 118 may determine the explanation with highest combined mean value. The final determined explanation of the generated trend forecast may be output on the graphical/display user interface associated with the system 100.

In one embodiment, the AI training module 120 may include a plurality of neural network layers. Each layer has a plurality of weight values and performs a neural network layer operation through calculation between a result of computation of a previous layer and an operation of a plurality of weights. In particular, the AI training module 120 may include AI models that are used by the processor 102 for generating the trend forecast of the data model. The AI models may include, but are not limited to, Ensemble models, support vector machines (SVM) based models, and neural network (NN) models including at least one of wide neural network (WNN) model, bilayer neural network (BNN) model, and medium neural network model.

Further, the AI training module 120 is configured to train AI models of the 114-118 based on the instructions under the control of the processor 102. In an embodiment, there are various computations involved in the training process of the AI training module 120. Here, “training” means that a predefined operation rule or artificial intelligence model configured to perform the desired feature (or purpose) is obtained by training a basic artificial intelligence model with multiple pieces of training data by a training technique. The learning may be performed in the system itself in which AI according to an embodiment is performed, and/or may be implemented through a separate server/system.

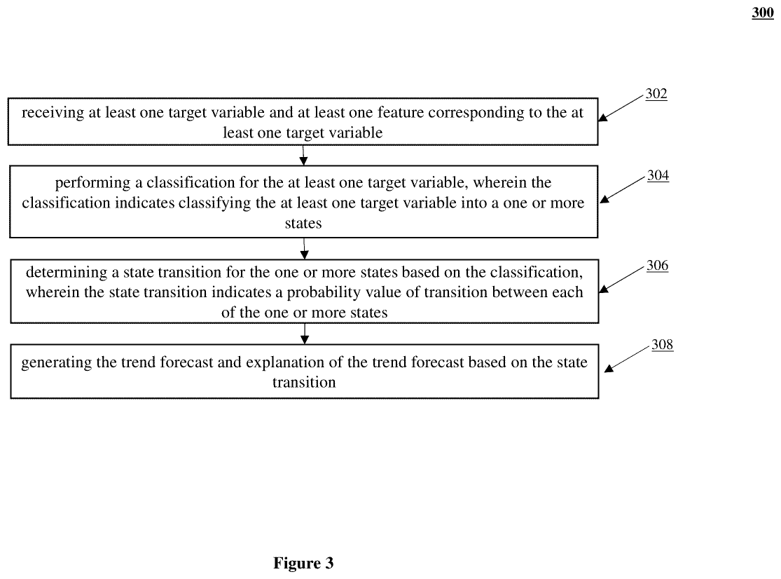

FIG. 3 illustrates an exemplary process flow comprising a method 300 for generating the trend forecast and the explanation of the trend forecast of the data model, according to an embodiment of the present disclosure. For the sake of brevity, details of the present disclosure that are explained in detail in the description of FIG. 1 and FIG. 2 are not explained in detail in the description of FIG. 3.

At step 302, the method 300 may include receiving, by the input module 114, receiving the target variable and the feature corresponding to the target variable.

In some embodiments, the method 300 may include receiving, by the input module 114 the data model. The data model may include historical data or of the car sales or historical data of the stock price.

The target variable may indicate the attribute or element represented in the data model for which the trend forecast needs to be generated. Further, the set of features may indicate representation of properties corresponding to the target variable. The set of features may include, but not limited to, information content, correlation and other metrices such as temperature indices, automotive market indices, stock price of relevant companies.

In some embodiments, the method 300 may include receiving, by the input module 114 one or more states. The one or more states may indicate divisions in the data model in which the target variable may be classified based on the predefined condition. For example, the one or more states may include, but not limited to a high, a medium, and a low state of stock price, a high, a medium, a low state of temperature, plummet, and recovery from plummet. In the example, the predefined condition of the stock price or the temperature may be defined for each of the one or more states. Thus, the target variable i.e., the stock price or the temperature may be classified as in the state of high, medium, low based on the predefined condition that the target variable demonstrates in the data model. For example, the predefined condition for each of the one or more states, may be, but limited to: High: if temperature (target variable) is greater than 100° C.; Medium if temperature (target variable) is between 50° C.-100° C.; Low if temperature (target variable) is below 50° C.

In some embodiments, the method 300 may include receiving, by the input module 114 the input for selecting the logic for generating the trend forecast in form of a user-defined trend input. The trend input may indicate a pattern for generating the trend forecast based on the one or more states defined by the user. For example, the trend input may include, but not limited to, recovery from monotonic decrease in temperature, plummet recovery of the stock price.

At step 304, the method 300 may include performing the classification, by the classification module 116 of the target variable. The classification indicates classifying the target variable into the one or more states provided as input.

In some embodiments, the method 300 may include, applying, by the classification module 116, the Markov-chain model for classifying the target variable such that the target variable with continuous variables is classified into one or more states of discrete variables. In the example, based on the predefined condition provided in the above step 302, the target variable may be classified into the one or more states.

In some embodiments, the method 300 may include generating, by the classification module 116, the state transition probability matrix. The state transition probability matrix may indicate probabilities of the target variable transitioning from one state to another in a single time unit. The single time unit may also be known as the timestamp in the trend forecast indicating a specific time for which the state transition probability matrix may be generated.

At step 306, the method 300 may include applying the Markov-chain model, by the classification module 116 to determine the state transition or the state transition probability matrix for the one or more states based on the classification of the target variable from the data model to generate the state transition probability matrix. The state transition indicates the probability value for transition of the target variable between each of the one or more states and can be represented by the transition probability score.

At step 308, the method 300 may include generating, by the output module 118, the trend forecast based on the transition probability score and the user-defined trend input.

In some embodiments, the method 300 may include selecting, by the output module 118 the feature for generating the explainability of the trend forecast. In an example, the feature may be selected using sparse feature selection method such as LassoNet.

In some embodiments, the method 300 may include generating, by the output module 118, the explanation of the generated trend forecast based on the selected feature. In an example, the SHAP technique is used to generate explanation of the generated trend forecast.

In some embodiments, the method 300 may include determining, by the output module 118, quality of the generated explanation. The informative score and the relevance score is generated for the generated explanation.

In some embodiments, the method 300 may include selecting, by the output module 118, the explainability based on the informative score and the relevance score.

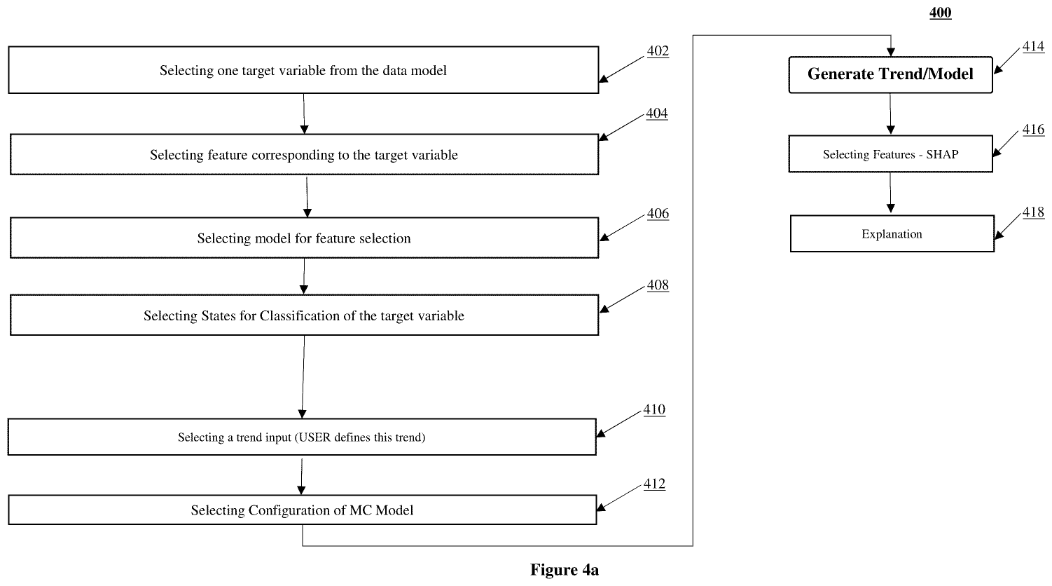

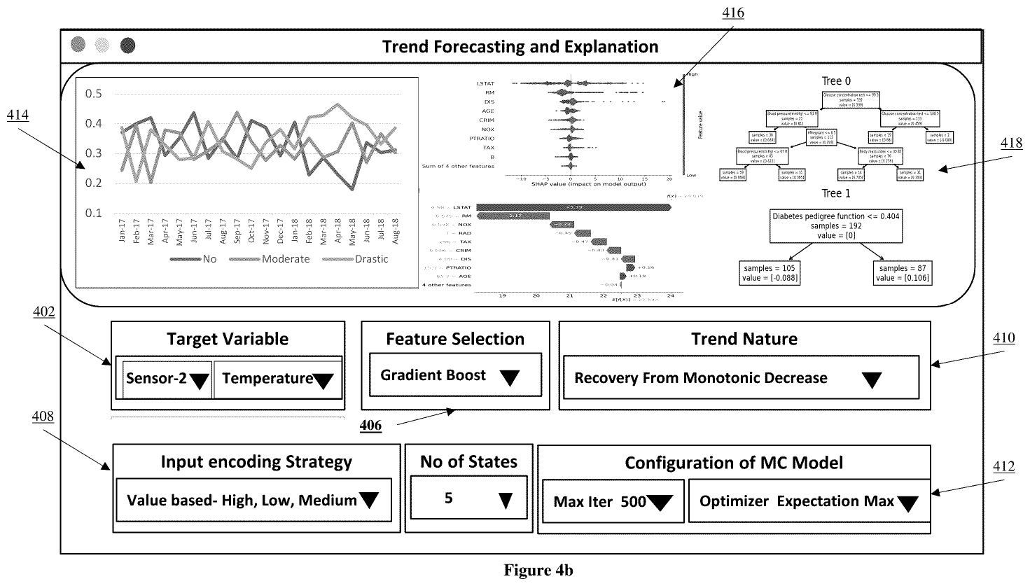

FIGS. 4A and 4B illustrate another exemplary process flow comprising a method 400a and a graphical user interface (GUI) 400b respectively for generating the trend forecast and the explanation of the trend forecast of the data model, according to an embodiment of the present disclosure.

At step 402, the method 400a comprises selecting the target variable from the data model.

At step 404, the method 400a comprises selecting the set of features corresponding to the data model and the target variable.

At step 406, the method 400a comprises selecting a model for feature selection. The models may include, for example, but not limited to, gradient boost, random forest, neural network.

At step 408, the method 400a comprises selecting the one or more states that may provide logic for classifying the target variable into the one or more states based on the predefined condition provided by the user. The selection of one or more states is indicated as input encoding strategy in GUI.

At step 410, the method 400a comprises selecting the trend input, thereby providing the pattern for generating the trend forecast based on the one or more states.

At step 412, the method 400a comprises selecting criterion for optimizing the parameters of the Markov chain model. For example, the criterion may include maximum iterations, error function, regularization function etc. In an example, a data driven variant of Markov chain model may be used.

At step 414, the method 400a comprises running the model such that the trend forecast is generated. In an example, the trend forecast indicates a probability of respective attribute such as, but not limited to, a maximum likelihood. In the example, y-axis represent scores computed based on values from the transition probability matrix and x-axis represent timeline.

At step 416, the method 400a comprises determining employing SHAP to generate the explainability of the generated trend forecast.

At step 418, the method 400a comprises the generated explainability of the generated trend forecast at step 414.

While the above steps are shown in FIGS. 3 and 4 and described in a particular sequence, the steps may occur in variations to the sequence in accordance with various embodiments of the present disclosure. Further, the details related to various steps of FIGS. 3 and 4, which are already covered in the description related to FIGS. 1-2 are not discussed again in detail here for the sake of brevity.

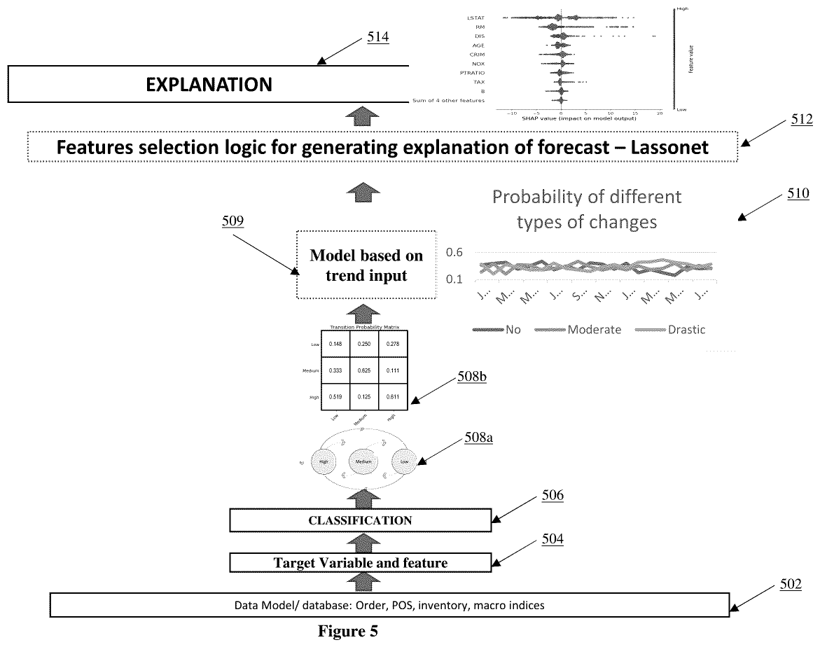

FIG. 5 illustrates another exemplary block diagram depicting a process flow for generating the trend forecast and the explanation of the trend forecast of the data model, according to an embodiment of the present disclosure.

As depicted, the data model which may include, but not limited to, historical data such as order, POS, inventory, macro indices are fed as input features from a database at step 502. Specifically, at the bottom of this architecture, there is a database that includes the auxiliary data such as stock price, macroeconomic indices, automotive market indices.

Further at step 504, the target variable and the features to the machine learning models to generate the trend forecast are received as input from the data model of the step 502.

At step 506, the classification for the target variable is performed. The classification is performed based on one or more states and the predefined condition for each state provided as input to the model.

At step 508a, upon classification, the Markov Chain Model is applied to the one or more states.

In continuation with 508b, the Markov Chain Model leads to generation of the state transition probability matrix. The state transition probability matrix provides the state transition for the one or more states based on the classification. The state transition includes the transition probability score for each of the one or more states in the state transition.

At step 509, the user may define the desired trend input. Thus, indicating the pattern for generating the trend forecast. For example, recovery of stock price from the plummet.

At step 510, as illustrated, in this example, the machine learning models are applied to generate the trend forecast. The machine learning models may include linear regression, support vector regression, principal component regression, K-nearest neighbour.

At step 512, the features may be selected from the generated trend forecast. For example, Lassonet may be applied to select the features.

At step 514, the explanation of the generated trend forecast is generated.

Thus, the step 510 and step 514 provide a desired output of the system 100 in form of the generated trend forecast and the explainability of the trend forecast.

Additionally, based on implementation of the proposed method for products with real datasets, the results demonstrate that there is a significant improvement in the robustness of the generated trend forecast as multiple factors as defined by the user are considered for predicting the future timeseries. Further, customized explainability is also generated for the trend forecast.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

I/We claim:

1. A method for generating a trend forecast and an explanation of the trend forecast of a data model representing a process, the method comprising:
receiving at least one target variable and at least one feature corresponding to the at least one target variable,
wherein the at least one target variable indicates an attribute represented in the data model and the at least one feature indicates representation of properties corresponding to the data model;
performing a classification for the at least one target variable, wherein the classification indicates classifying the at least one target variable into a one or more states;
determining a state transition for the one or more states based on the classification, wherein the state transition indicates a probability value of transition between each of the one or more states; and
generating the trend forecast and an explanation of the trend forecast based on the state transition.

2. The method of claim 1, wherein the state transition is determined for at least one timestamp in the data model based on a Markov Chain Model (MCM) wherein the MCM indicates a framework including functions to model and determine the probability value corresponding to the to the one or more states of interest based on a user requirement.

3. The method of claim 1, further comprising:
receiving a user-defined trend of interest indicating a pattern for generating the trend forecast based on the one or more states;
determining a transition probability matrix, wherein the transition probability matrix includes a transition score indicating the probability of transition between the each of two states;
selecting the transition score corresponding to the one or more states of interest from the transition probability matrix; and
generating the trend forecast based on the transition score corresponding to user-defined trend of interest.

4. The method of claim 1, wherein generating the explanation of the trend forecast comprises:
selecting the generated trend forecast and the state transition matrices;
selecting at least one feature from the generated trend forecast; and
generating the explanation of the generated trend forecast based on the at least one feature.

5. The method of claim 4, wherein the explanation is generated based on at least one of an informativeness score and a relevance score.

6. The method of claim 4, wherein the explanation is generated based on one of a Shapley Additive Explanations (SHAP) technique, rule based technique including ruleset, rule-list.

7. A system for generating a trend forecast and an explanation of the trend forecast of a data model, the system comprises:
a memory;
at least one processor communicably coupled to the memory, the at least one processor is configured to:
receive at least one target variable and at least one feature corresponding to the at least one target variable,
wherein the at least one target variable indicates an attribute represented in the data model and the at least one feature indicates representation of properties corresponding to the data model;
perform a classification for the at least one target variable, wherein the classification indicates classifying the at least one target variable into a one or more states;
determine a state transition for the one or more states based on the classification, wherein the state transition indicates a probability value of transition between each of the one or more states; and
generate the trend forecast and an explanation of the trend based on the state transition.

8. The system of claim 7, wherein the at least one processor is configured to:
determine the state transition for at least one timestamp in the data model based on a Markov Chain Model (MCM), wherein the MCM indicates a framework including functions to model and determine the probability value corresponding to the to the one or more states of interest based on a user requirement.

9. The system of claim 7, at least one processor is further configured to:
receive a user-defined trend of interest indicating a pattern for generating the trend forecast based on the one or more states;
determine a transition probability matrix, wherein the transition probability matrix includes a transition score indicating the probability of transition between the each of two states
select the transition score corresponding to the one or more states of interest from the transition probability matrix; and
generate the trend forecast based on the transition score corresponding to the user-defined trend input of interest.

10. The system of claim 7, wherein the at least one processor is configured to:
select the generated trend forecast and the state transition matrices;
select at least one feature from the generated trend forecast; and
generate the explanation of the generated trend forecast based on the at least one feature.

11. The system of claim 10, wherein the explanation is generated based on at least one of an informativeness score and a relevance score.

12. The system of claim 10, wherein the explanation is generated based on a Shapley Additive Explanations (SHAP) technique, rule based technique including ruleset, rule-list.
